(19) United States
(12) Patent Application Publication
(10) Pub. No.: US 2009/0282768 A1
(43) Pub. Date: Nov. 19, 2009

(54) Plywood clip for use in roofing

(75) Inventor: Sam P. Noturno, Canton, OH (US)

Correspondence Address: SAND & SEBOLT, AEGIS TOWER, SUITE 1100, 4940 MUNSON STREET, NW, CANTON, OH, 44718-3615, US

(73) Assignee: Inventech, Inc., North Canton, OH (US)

(21) Appl. No.: 12/284,928

(22) Filed: Sep. 26, 2008

Related U.S. Application Data
(60) Provisional application No. 61/128,017, filed on May 19, 2008.
(60) Provisional application No. 61/133,583, filed on Jul. 1, 2008.

(51) Int. Cl. F16B 5/00; E04F 13/08

(52) U.S. Cl. 52/582.1

(57) ABSTRACT

A panel clip configured primarily for use in roofing defines lower and upper spaces for respectively receiving therein the edge of a first panel and the edge of a second panel to help maintain the two panels in a coplanar relationship. Specially configured teeth extend into the lower space to inhibit removal of the first panel from the lower space. The clips are typically used midway between the rafters of a roof to provide additional support to the panels.

### CROSS REFERENCE TO RELATED APPLICATIONS

This application claims priority from U.S. Provisional Application Ser. No. 61/128,017, filed May 19, 2008, and U.S. Provisional Application Ser. No. 61/133,583, filed Jul. 1, 2008; the disclosure of which is incorporated herein by reference.

### BACKGROUND OF THE INVENTION

1. Technical Field

The present invention relates generally to a clip for retaining plywood or other roof sheeting in a coplanar relationship. More particularly, the invention relates to such a clip having barb-like teeth which dig into the plywood to prevent the clip from falling off during installation of the adjacent plywood panels.

2. Background Information

A typical roof is generally formed by attaching panels to roof trusses or rafters by the use of nails or other fasteners. It is common in current construction to use plywood clips which are positioned typically midway between the trusses in order to provide an additional connection between a pair of coplanar panels in order to reduce deflection of the panels between the rafters. Roofing panels are typically formed of plywood, oriented strand board (commonly known as OSB) or other particle board although any suitable panel may be used. These panels are most typically four foot by eight foot panels and are commonly about a half inch thick. The standard plywood clip currently used in the industry is shown in FIG. 1 of U.S. Pat. No. 5,966,893 granted to Quillin. While this standard clip serves its purpose in reducing deflection between the adjacent pieces of plywood or other panels, it has a tendency to fall off during installation of the roof, particularly as a new panel is moved into position adjacent another panel which is already secured to the rafters. The falling off of the clips during installation requires that the lost clip must be replaced, which is a time consuming, awkward and potentially dangerous situation. In order to replace these lost clips, the roofer must typically either place the sheeting panel aside completely or hold it up with one foot while replacing the lost clip. This process increases the dangers to roofers especially on steep roofs. There is thus a need in the art for a clip which is not inadvertently knocked off during installation. At lease one prior art clip utilizes elongated ridges in order to help secure the clip to the edge of the plywood, as illustrated in U.S. Pat. No. 4,703,603 granted to Hills. However, it has been found that such a configuration is not always sufficient for various reasons.

### BRIEF SUMMARY OF THE INVENTION

The present invention provides a panel clip for use with a first panel having a first edge and a second panel having a second edge, the clip comprising a base wall having a front, a back, a left side and a right side; front and back lower walls which are secured to and extend downwardly from the base wall in a cantilever fashion to define therebetween a lower panel-edge receiving space configured to receive the first edge of the first panel; front and back upper walls which are secured to and extend upwardly from the base wall in a cantilever fashion to define therebetween an upper panel-edge receiving space configured to receive the second edge of the second panel so that the first and second panels are substantially coplanar when the first and second edges are received respectively in the upper and lower spaces; wherein the upper and lower walls are substantially parallel; and a first front tooth having a base secured to the front lower wall and extending upwardly therefrom in cantilever fashion to a tip which extends into the lower space whereby the first front tooth is configured to engage the first panel to inhibit removal of the first panel from the lower space.

The present invention also provides a panel clip for use with a first panel having a first edge and a second panel having a second edge, the clip comprising a base wall having a front, a back, a left side and a right side; front and back lower walls which are secured to and extend downwardly from the base wall in a cantilever fashion to define therebetween a lower panel-edge receiving space configured to receive the first edge of the first panel; front and back upper walls which are secured to and extend upwardly from the base wall in a cantilever fashion to define therebetween an upper panel-edge receiving space configured to receive the second edge of the second panel so that the first and second panels are substantially coplanar when the first and second edges are received respectively in the upper and lower spaces; wherein the upper and lower walls are substantially parallel; an opening formed through the front lower wall in communication with the lower space; and one of (a) a left front tooth connected to and extending in a cantilever fashion from the left wall segment to the right into the opening and to a tip which extends into the lower space whereby the left front tooth is configured to engage the first panel to inhibit removal of the panel from the lower space; and (b) a right front tooth connected to and extending in a cantilever fashion from the right wall segment to the left into the opening and to a tip which extends into the lower space whereby the right front tooth is configured to engage the first panel to inhibit removal of the panel from the lower space.

The present invention further provides a panel clip for use with a first panel having a first edge and a second panel having a second edge, the clip comprising a base wall having a front, a back, a left side and a right side; front and back lower walls which are secured to and extend downwardly from the base wall in a cantilever fashion to define therebetween a lower panel-edge receiving space configured to receive the first edge of the first panel; front and back upper walls which are secured to and extend upwardly from the base wall in a cantilever fashion to define therebetween an upper panel-edge receiving space configured to receive the second edge of the second panel so that the first and second panels are substantially coplanar when the first and second edges are received respectively in the upper and lower spaces; wherein the upper and lower walls are substantially parallel; and one of (a) a lower base wall tooth connected to the base wall between the front and back lower walls and extending downwardly in a cantilever fashion from the base wall to a tip which is configured to be inserted into the first edge of the first panel when received in the lower space; and (b) an upper base wall tooth connected to and extending upwardly in a cantilever fashion from the base wall to a tip which is configured to be inserted into the second edge of the second panel when received in the upper space.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a perspective view of a first embodiment of the clip of the present invention.

FIG. 2 is a front elevational view of the first embodiment.

FIG. 2A is an enlarged view of the encircled portion of FIG. 2.

FIG. 3 is a side elevational view of the first embodiment.

FIG. 4 is a top plan view of a portion of a roof showing an initial stage of installing the clip and panels to form the roof.

FIG. 5 is an enlarged view of a portion of one of the roofing panels and one of the clips of the first embodiment just prior to installation of the clip on the lower panel.

FIG. 6 is similar to FIG. 5 and shows the clip of the first embodiment installed on the lower panel and a portion of the upper panel positioned prior to installation.

FIG. 7 is similar to FIG. 6 and shows the upper panel installed on the clip.

FIG. 8 is a sectional view taken on line 8-8 of FIG. 7.

FIG. 9 is a perspective view of a second embodiment of the clip of the present invention.

FIG. 10 is a front elevational view of the second embodiment.

FIG. 11 is a side elevational view of the second embodiment.

FIG. 12 is similar to FIG. 7 and shows two panels joined by one of the clips of the second embodiment.

FIG. 13 is a sectional view taken on line 13-13 of FIG. 12.

FIG. 14 is a front elevational view of a third embodiment of the clip of the present invention.

FIG. 15 is a side elevational view of the third embodiment.

FIG. 16 is similar to FIGS. 7 and 12 and shows two panels joined by one of the clips of the third embodiment.

FIG. 17 is a sectional view taken on line 17-17 of FIG. 16.

Similar numbers refer to similar parts throughout the drawings.

### DETAILED DESCRIPTION OF THE INVENTION

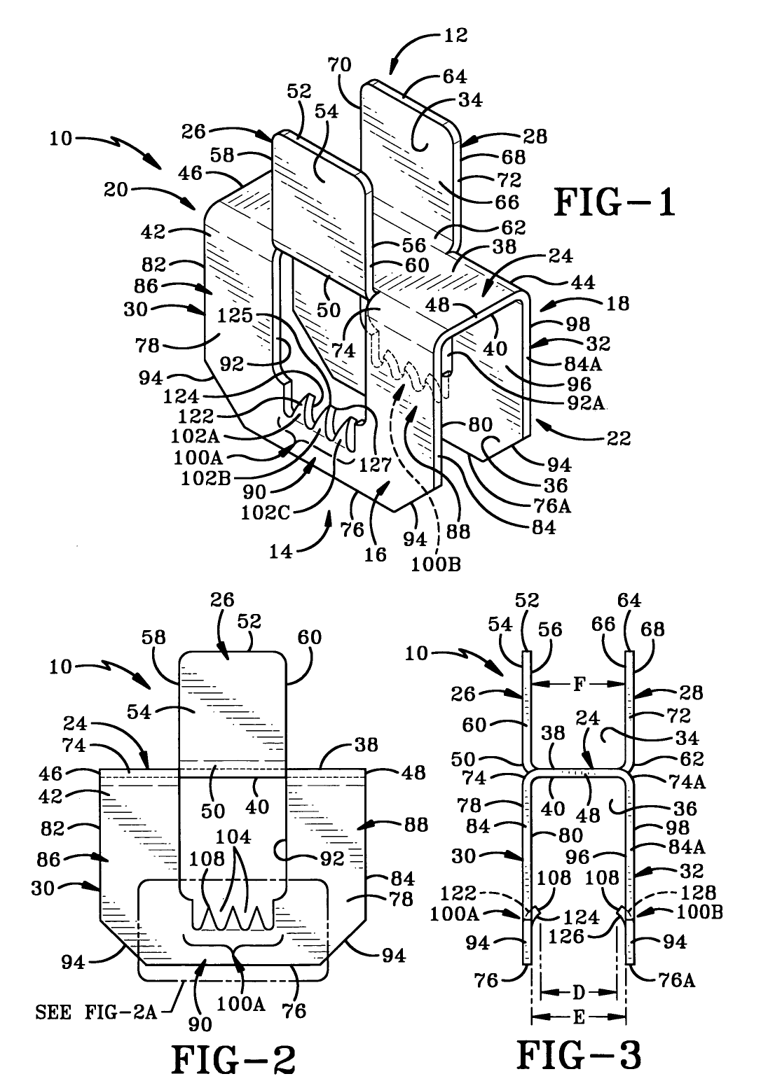

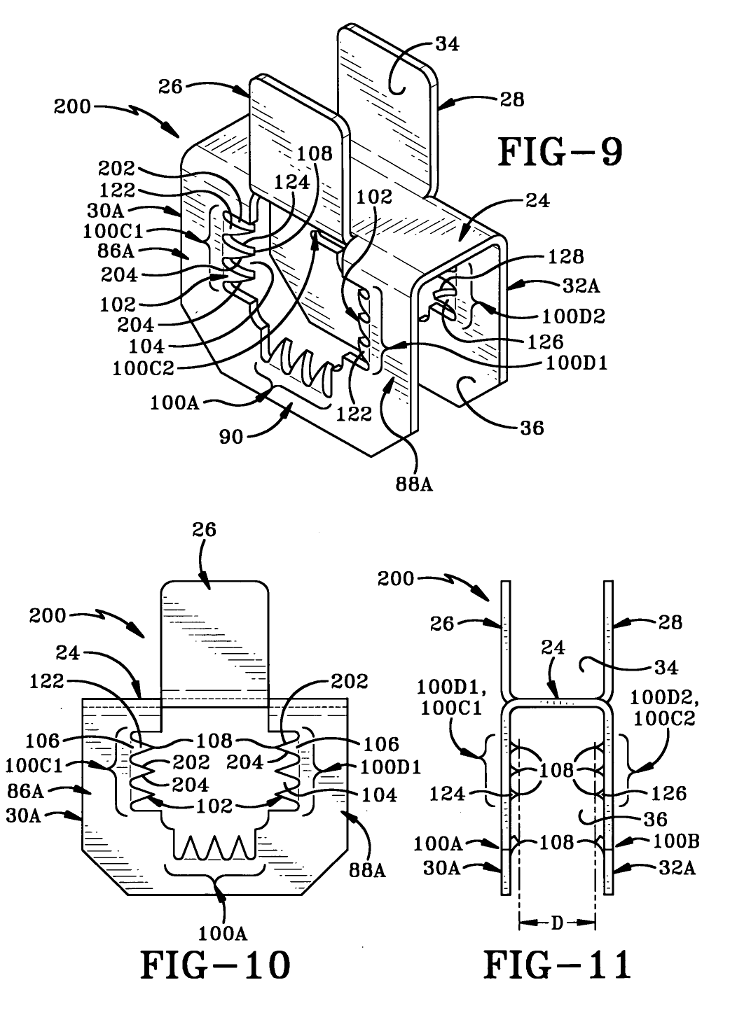

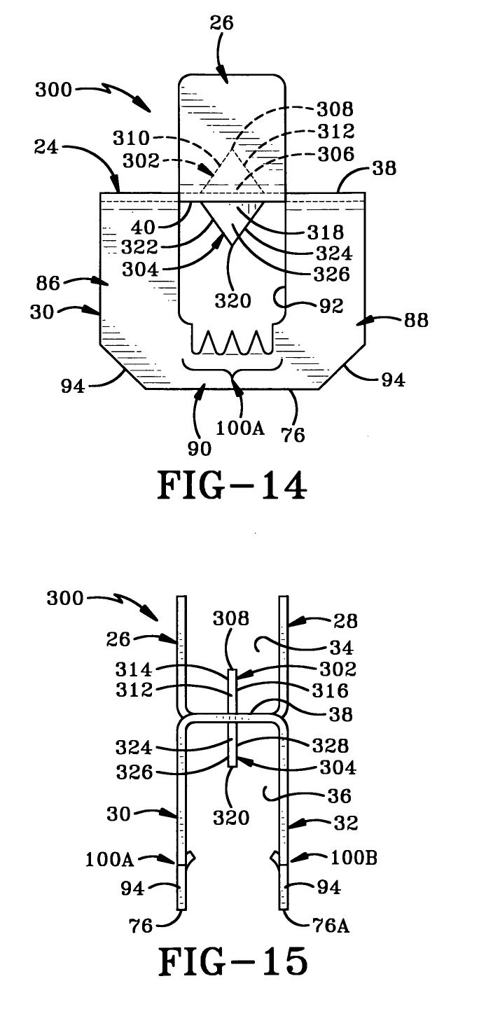

A first embodiment of the clip of the present invention is shown generally at 10 in FIG. 1; a second embodiment of the clip of the present invention is shown generally at 200 in FIG. 9; and a third embodiment of the clip of the present invention is shown generally at 300 in FIG. 14. Each of these clips is used in joining a pair of adjacent roofing panels in an edge to edge and coplanar relationship with one another.

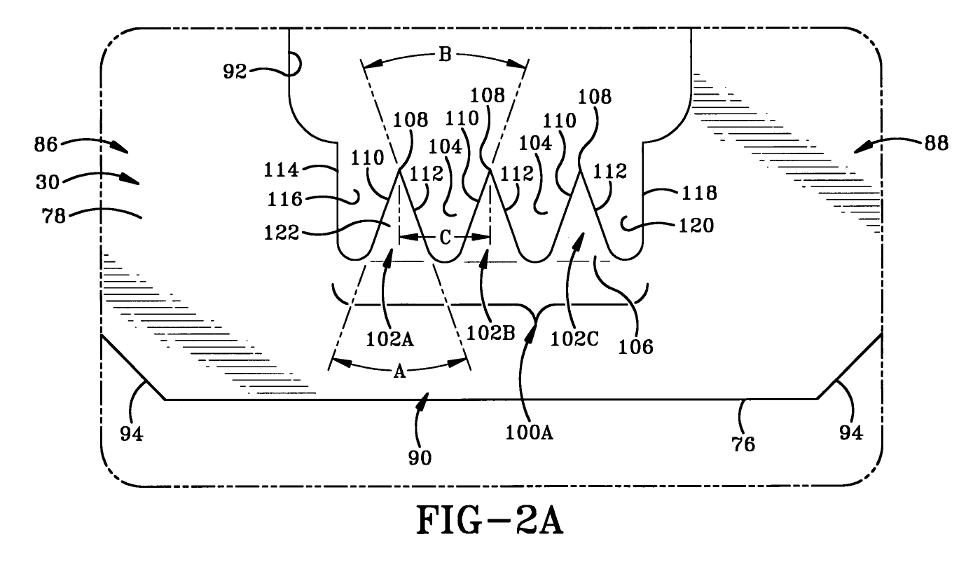

With reference to FIGS. 1-3, clip 10 has a top 12, and bottom 14, and front 16, a back 18, and left and right sides 20 and 22. Clip 10 includes a base wall 24, rectangular upper front and back walls 26 and 28, and lower front and back walls 30 and 32. Upper front and back walls 26 and 28 define there between an upper panel edge receiving space 34. Likewise, lower front and back walls 30 and 32 define there between a lower panel edge receiving space 36. Base wall 24 is substantially flat and rectangular and in the orientation shown is substantially horizontal. Base wall 24 has a substantially flat rectangular upwardly facing top surface 38 which bounds space 34, a substantially flat rectangular downwardly facing bottom surface 40 which bounds space 36, a front 42, a back 44, and left and right sides or terminal edges 46 and 48. Front upper wall 26 has a bottom 50 which is rigidly secured to the front 42 of base wall 24 and extends upwardly there from in a cantilever fashion to a horizontal terminal top edge 52. Upper front wall 26 has a substantially flat and vertical front surface 54 which faces away from space 34 and an opposed substantially flat smooth vertical back surface 56 which is parallel to front surface 54 and bounds space 34. Upper front wall 26 has left and right vertical terminal edges 58 and 60 which are respectively spaced inwardly from edges 46 and 48 of base wall 24.

Upper back wall 28 has a bottom 62 which is rigidly secured to back 44 of base wall 24 and extends upwardly therefrom in a cantilever fashion parallel to front wall 26 to a horizontal terminal top edge 64. Upper back wall 28 has a substantially flat smooth vertical front surface 66 which bounds space 34 and an opposed substantially flat vertical back surface 68 which is parallel to surface 66 and faces away from space 34. Upper back wall 28 has vertical left and right edges 70 and 72 which are respectively spaced inwardly from edges 46 and 48 of base wall 24 the same distance as are left and right edges 58 and 60 from front wall 26.

Lower front wall 30 has a top 74 which is rigidly secured to front 42 of base wall 24 and extends downwardly therefrom in a cantilever fashion to a terminal bottom edge 76. Front lower wall 30 has a substantially flat vertical front surface 78 which faces away from space 36 and an opposed substantially flat vertical rearwardly facing back surface 80 which faces back wall 32 and bounds space 36. Lower front wall 30 has left and right terminal edges 82 and 84 which are respectively aligned with edges 46 and 48 of base wall 24 whereby the length of walls 24 and 30 from left to right is substantially the same. Front lower wall 30 has a U-shaped configuration as viewed from the front and includes left and right segments 86 and 88 which are rigidly secured to opposed ends of a bottom segment 90 and extend upwardly therefrom to define therebetween a front through opening 92 which communicates with space 36. Wall 30 has beveled corners 94 each communicating with bottom edge 76 and a respective one of left and right edges 82 and 84.

Lower back wall 32 is substantially a mirror image of lower front wall 30 and thus not described in as great detail. It is noted that several of the numbers referring to portions of back wall 32 are numbered in a similar fashion as the parts of front wall 30 except followed by the alpha indicator “A”. Thus, for instance, the bottom edge of front wall 30 is denoted at 76 and the bottom edge of back wall 32 is denoted at 76A and so forth. However, the front and rear surfaces of lower back wall 32 are distinctly denoted respectively at 96 and 98. Front surface 96 is generally U-shaped, flat and vertical and faces back surface 80 of lower front wall 30 and also bounds space 36. Back surface 98 is also generally U-shaped and substantially flat and vertical and faces away from space 36.

In accordance with a feature of the present invention, clip 10 includes front and rear sets 100A and 100B of triangular teeth 102A-C. Each adjacent pair of teeth 102 is separated by a triangular space 104 which is about the same size as teeth 102 and is inverted relative thereto. Each tooth 102 has a base 106 which is rigidly secured to the top of bottom segment 90 and tapers upwardly and inwardly therefrom in a cantilever fashion to a terminal sharp pointed tip 108. Each of teeth 102 is substantially identical and thus the tips 108 thereof are substantially at the same height. Each tooth has a tapered left side or edge 110 and a tapered right side or edge 112 each of which extends from base 106 to tip 108. Left edge 110 tapers upwardly and to the right from base 106 to tip 108 while right edge 112 tapers upwardly and to the left from base 106 to tip 108. Each left edge 110 thus faces left and upwardly while each right edge 112 faces right and upwardly. The left and right edges 110 and 112 of a given tooth 102 define therebetween an angle A which in the exemplary embodiment is about 45 degrees although this may vary. Each right side 112 of a given tooth 102 and the left side 110 of an adjacent tooth 102 bounds the triangular space 104 therebetween and also defines therebetween an angle B which in the exemplary embodiment is also about 45 degrees although this may vary. The left edge 110 of left tooth 102A and a lower right edge 114 of left segment 86 define therebetween a triangular space 116. Likewise, the right edge 112 of right tooth 102C and a lower left edge 118 of right segment 88 define therebetween triangular space 120. Each of triangular spaces 104, 116 and 120 are part of opening 92. Thus, each tooth 102 projects upwardly into space 92.

Each of sets 100A and 100B of teeth 102 are bent inwardly so that the respective tips 108 of the teeth in 100A extend toward the tips 108 of the teeth 102 in set 100B and vice versa. Thus, each tooth 102 in set 100A has a convexly curved front surface 122 and concavely curved back surface 124 which is in keeping with the teeth being bent or curved from the respective base 106 thereof upwardly and rearwardly to the respective tip 108 thereof. In addition, front and back surfaces 122 and 124 are common to or part of the front and back surfaces 78 and 80 of lower front wall 30. Each tooth 102 has a thickness defined between front and back surfaces 122 and 124 which is the same as the thickness of front lower wall 30 defined between front and back surfaces 78 and 80. The left and right edges 110 and 112 of each tooth 102 in set 100A curve upwardly and rearwardly. Front surface 122 intersects left and right edges 110 and 112 at a common point 125 (FIG. 1) at the front top of tip 108. Likewise, back surface 124 intersects left and right edges 110 and 112 at a common point 127 on tip 108 which is lower and rearward of point 125. Points 125 and 127 are thus terminal ends of tip 108, which angles downwardly and rearwardly from point 125 to point 127. Each tip 108 of the teeth in set 100A projects rearwardly beyond back surface 80 of lower front wall 30 into space 36. Typically, tips 108 of the teeth in set 100A project rearwardly of back surface 80 a distance in the range of about 1/32 inch to 1/16 or 3/32 inch and typically no further although this may vary. The tips 108 of each adjacent pair of teeth 102 are spaced apart from one another a distance C which in the exemplary embodiment is typically about ⅛ inch.

The teeth 102 of set 100B are substantially mirror images of teeth 102 of set 100A, and thus are connected to back wall 32 in the same manner, have substantially the same size and spacing from one another and so forth. Because teeth 102 of set 100B are mirror images of those in set 100A, the teeth 102 in set 100B thus are bent forward relative to back wall 32. Thus, each tooth 102 in set 100B has a concave front surface 126 which is substantially a mirror image of the concave back surface 124 of a corresponding tooth 102 in set 100A. Likewise, each tooth 102 in set 100B has a convex back surface 128 which is a mirror image of the convex front surface 122 of a corresponding tooth 102 in set 100A.

As shown in FIG. 3, the rearmost portion of tips 108 of teeth 102 in set 100A and the forward most portion of tips 108 of teeth 102 in set 100B define therebetween a normal distance D which is slightly less than a distance E defined between back surface 80 of front wall 30 and front surface 96 of back wall 32. It is further noted that back surface 56 of upper front wall 26 and front surface 66 of upper rear wall 28 define therebetween a normal distance F which is typically the same as or similar to distance B.

In the exemplary embodiment, clip 10 is formed as an integral one piece member which is stamped out of a single piece of flat sheet metal. Thus, upper walls 26 and 28 are stamped in order to separate from the lower U-shaped walls 30 and 32 respectively. Walls 26 and 28 are thus bent upwardly relative to base wall 24 out of openings 92, while walls 30 and 32 are bent downwardly relative to base wall 24 so that walls 26, 28, 30 and 32 are all substantially parallel to one another and perpendicular to base wall 24. Typically, formation of upper walls 26 and 28 involves an additional step in that the stamping process forms two walls which are the shape of openings 92, including teeth which are the shape of triangular spaces 104, 116 and 120. After these two walls with the teeth are removed from spaces 92, the teeth thereon are cut off, ground off or otherwise removed in order to provide the substantially smooth and flat top edges 52 and 64 of upper walls 26 and 28.

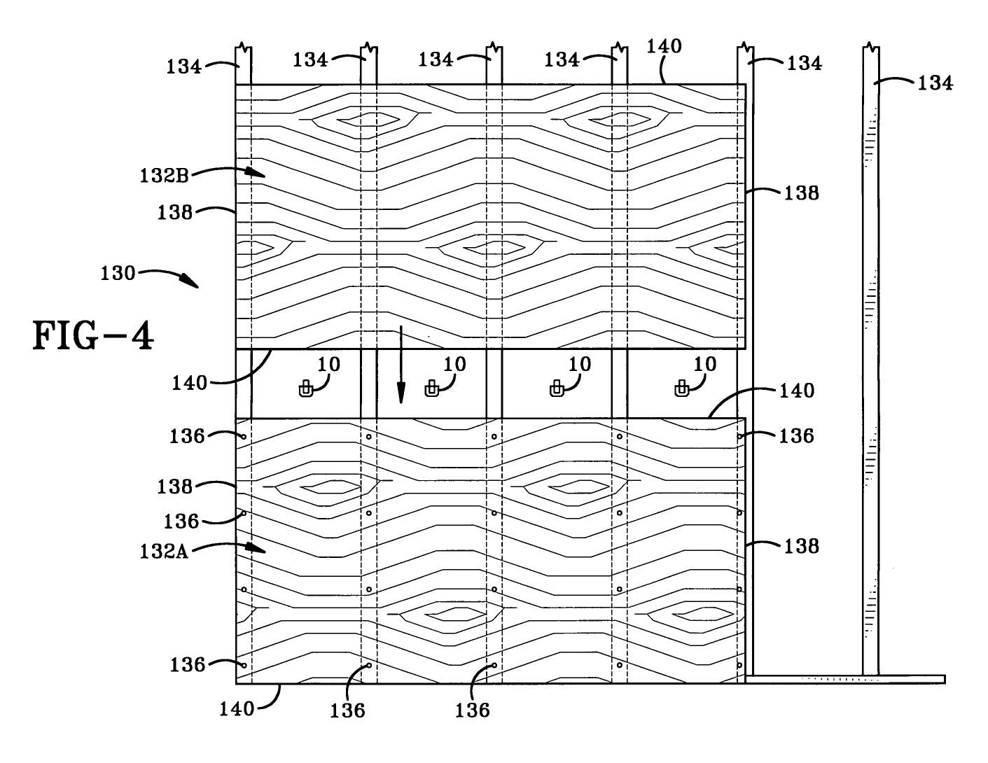

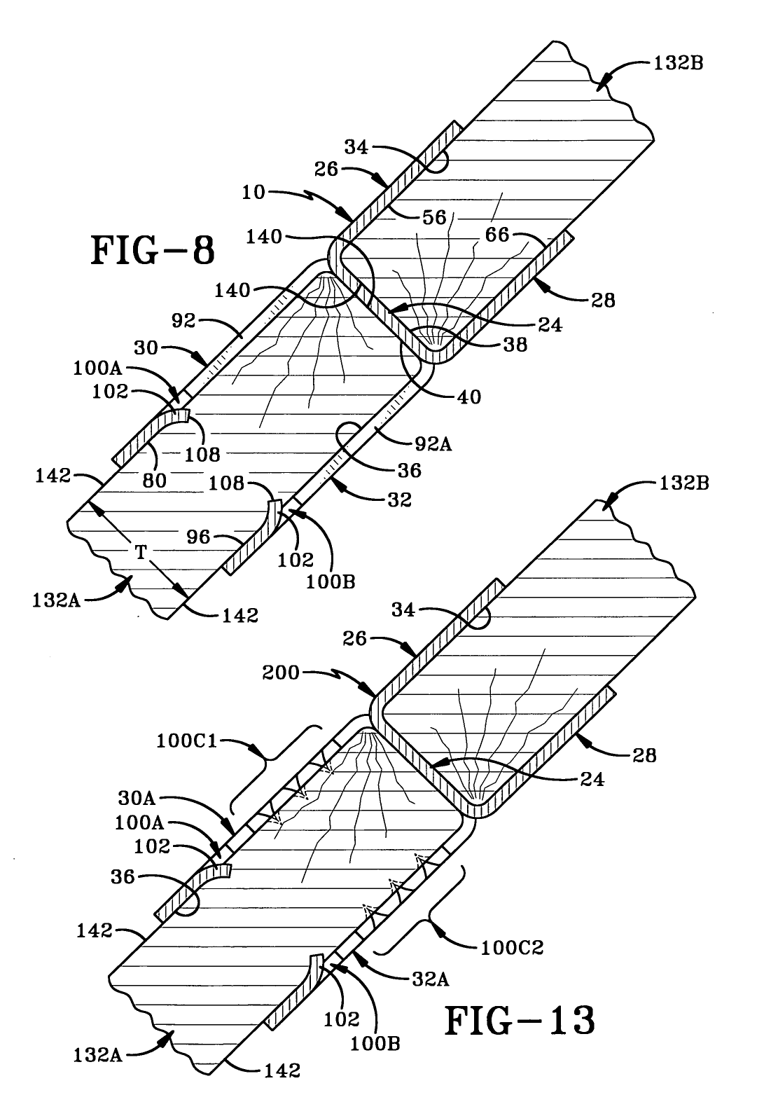

The use of clips 10 is now described with reference to FIGS. 4-8. FIG. 4 shows an initial stage of forming a roof 130 by securing panels 132A and B to the inclined trusses or rafters 134 of the roof. While the spacing between rafters 134 may vary, a common spacing is approximately 24 inches between the centers of the rafters which typically provides approximately a 22.5 inch spacing between each adjacent pair of rafters. As FIG. 4 shows, panel 132A is secured to five rafters 134 with fasteners 136 most typically in the form of nails although other common fasteners such as screws may be utilized. Each panel 132 is typically formed of plywood, OSB another type of particle board or the like. Each panel 132 has opposed end edges 138 defining therebetween a length which is typically on the order of approximately eight feet. Each panel 132 also has opposed side edges 140 defining therebetween a width which is typically on the order of approximately four feet. Each panel 132 further includes opposed flat surfaces 142 (FIG. 8) which are substantially rectangular and thus typically have a dimension of approximately four feet by eight feet. Surfaces 142 define therebetween a distance T (FIG. 8) which is typically slightly less than distance E and distance F and slightly larger than distance D.

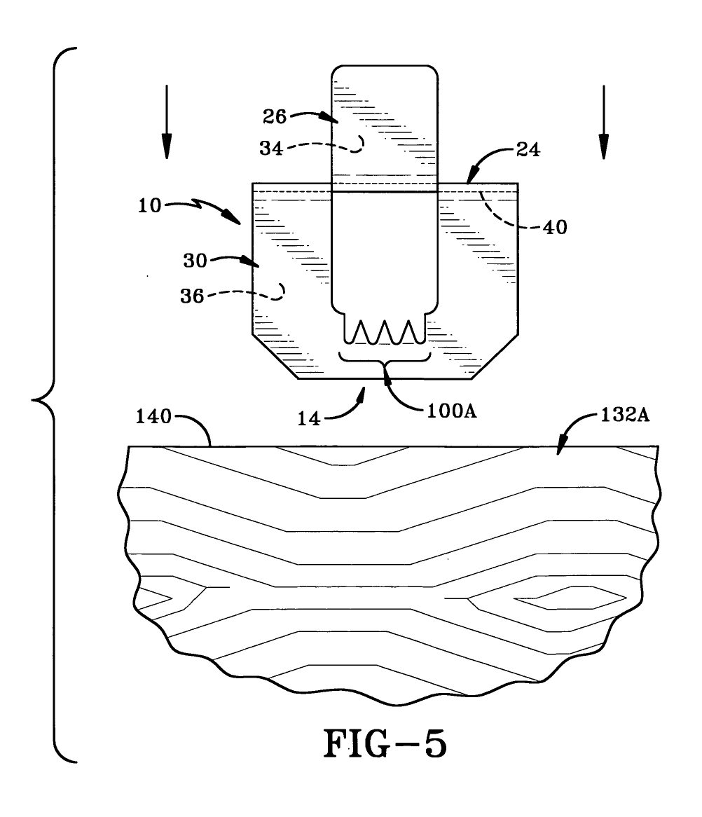

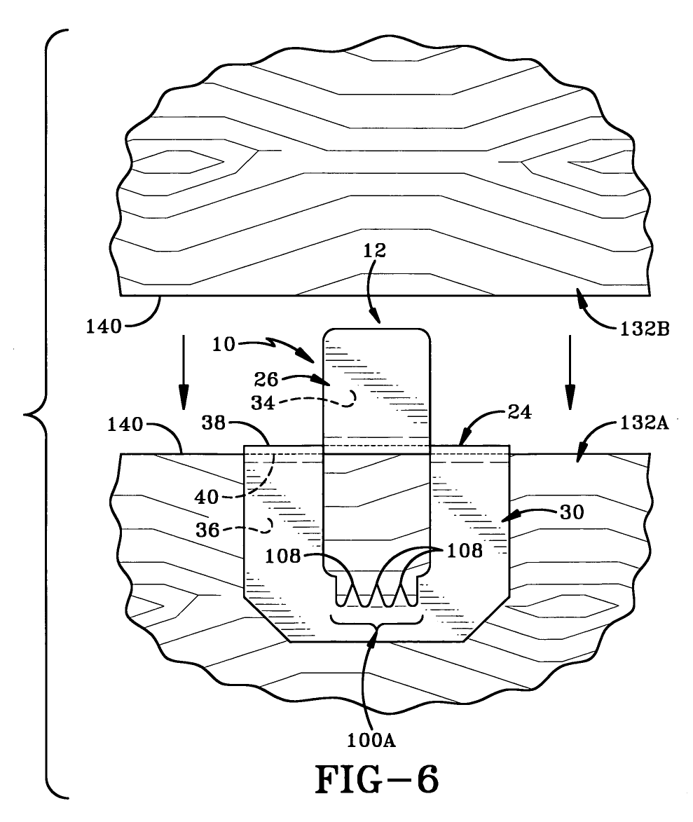

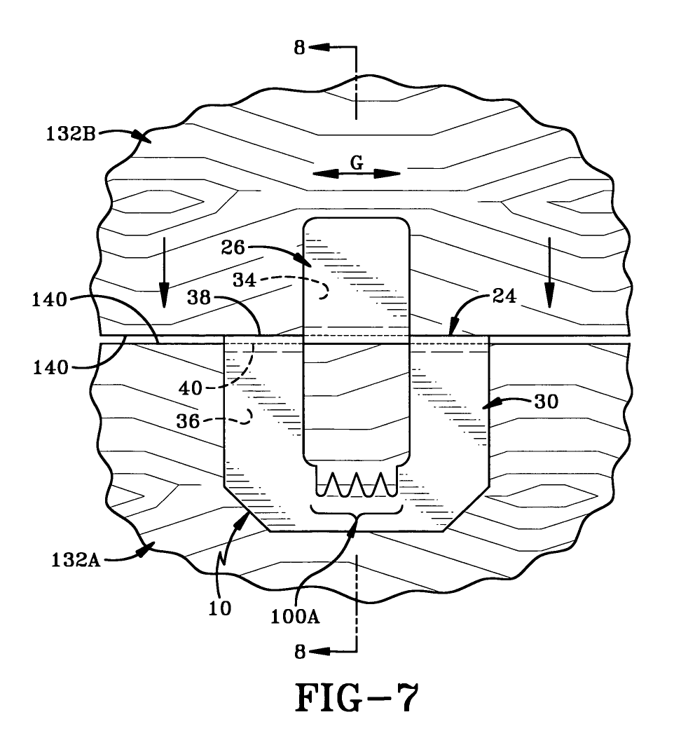

As shown generally in FIG. 4, clips 10 are positioned intermediate respective adjacent pairs of rafters 134, typically about midway therebetween. As illustrated in FIGS. 5 and 6, each clip 10 then move downwardly parallel to the incline of rafters 134 toward the top side edge 140 so that side edge 140 and a portion of panel 132A adjacent edge 140 are slidably received within lower space 36 and so that the top edge 140 is closely adjacent or abuts the lower surface 40 of base wall 24, as shown in FIG. 6. When clip 10 slides into the secured position on panel 132A as shown in FIG. 6, base wall 24 is parallel to edges 140 and perpendicular to surfaces 142 and edges 138 of panel 132A. Walls 26, 28, 30 and 32 are thus parallel to surfaces 142 and perpendicular to edges 138 and 140. As clip 10 slides onto panel 132A, teeth 102 scratch or score panel 132A along its opposed surfaces 142. Thus, the tips 108 of teeth 102 dig into panel 132A as illustrated in FIG. 8 when clip 10 is secured on panel 132A. Tips 108 of teeth 102 thus engage panel 132A in a barb-like style which prevents clip 10 from being removed from panel 132A without a substantial effort. Any attempt to remove clip 10 by simply pulling it upwardly parallel to panel 132A thus tends to force tips 108 into panel 132A in order to prevent removal of clip 10 therefrom. Once clips 10 are secured in this manner to panel 132A intermediate the respective rafters 134, the second panel 132B is then positioned generally shown as in FIG. 4 co-planar with panel 132A and typically sitting atop rafters 134 parallel thereto so that panel 132B may be lowered in a direction parallel to panel 132A (FIGS. 6-7) so that a portion of panel 132B adjacent lower edge 140 is received within upper space 34 and lower edge 140 abuts or is closely adjacent (FIGS. 7-8) top surface 38 of base wall 24 and so that opposed surfaces 142 are closely adjacent or abut surfaces 56 and 66 of respective walls 26 and 28 (FIG. 8).

It is noted that upper walls 26 and 28 are in the exemplary embodiment free of teeth such as teeth 102 and free of elongated gripping ridges such as those shown in the previously mentioned U.S. Pat. No. 4,703,603 granted to Hills. Forming clip 10 without teeth or ridges on walls 26 and 28 thus allows for the lateral adjusting movement of panel 132B with its lower edge 140 within upper space 34 relative to clip 10 and panel 132A in a side to side direction parallel to edges 140 and base wall 24, as indicated at arrow G in FIG. 7. The ability to adjust panel 132B in this manner facilitates the ability to align panel 132B relative to rafters 134 so that panel 132B may likewise be joined to rafters 134 by fasteners 136 as discussed previously with respect to panel 132A. Panel 132B may also easily move up and down parallel to the incline of rafters 134 with its lower edge 140 within upper space 34, or into and out of space 34 if desired. Once panel 132B is secured to rafters 134, another set of clips 10 may be secured to the top edge 140 of panel 132B in the same manner as previously discussed in order to prepare for the insertion of yet another panel into the upper spaces of said clips. Clips 10 thus provide an additional connection between an adjacent pair of co-planar panels intermediate the rafters and helps prevent up and down deflection in the direction of the thickness of a panel relative to the other panel to which it is joined by the clips.

Referring now to FIGS. 9-11, clip 200 in described in greater detail. Clip 200 in similar to clip 10 except that it includes alternate lower front and back walls 30A and 32A. Each of walls 30A and 32A include bottom segment 90 and upwardly extending side segments 86A and 88A which are analogous to segments 86 and 88 of clip 10 but also include additional sets of teeth 102. More particularly, a front left set 100C1 of teeth 102 is formed on and extends from the right side of wall 86A to the right and rearwardly toward rear lower wall 32A. A mirror image rear left set 100C2 (FIG. 11) of teeth 102 is formed on wall 32A and also extends to the right and forward towards walls 30A and teeth 102 of set 100C1. Respective sets 100D1 and 100D2 of teeth 102 are formed respectively on walls 30A and 32A and extend to the left from the left side of the respective right upwardly extending segments and toward one another in the same manner as the teeth in sets 100C1 and 100C2. Like clip 10, clip 200 is substantially bilaterally symmetrical about a vertical plane which is parallel to walls 26, 28, 30A and 32A and cuts through the center of base wall 24. Each of clips 10 and 200 is also bilaterally symmetrical about a vertical plane which is perpendicular to walls 26 and 28 and cuts centrally through wall 24. Thus, the teeth 102 in set 100C1 are a substantial mirror image of the teeth in set 100D1 and the teeth in sets 100C2 and 100D2 are also substantially mirror images of one another. The tips 108 of teeth 102 within sets 100C and 100D project inwardly into lower space 36 about the same distance as do the tips 108 of teeth in sets 100A and 100B, and thus define there between the same distance D (FIG. 11). There are thus six sets of teeth 102 on clip 200. The tips 108 of the teeth 102 in lower front set 100A point upwardly and rearwardly while those in the rear lower set 100B point upwardly and forward. The teeth in front left set 100C1 point to the right and rearwardly while the teeth in rear left set 100C2 point to the right and forward. Similarly, the teeth in set 100D1 point to the left and rearwardly while the teeth in set 100D2 point to the left and forward. While the teeth in sets 100A and 100B are spaced horizontally from one another, the teeth in sets 100C and 100D are spaced vertically from one another. In the exemplary embodiment, the teeth in sets 100C and 100D are essentially identical to the teeth in sets 100A and 100B other than their orientation.

Thus, each tooth 102 in front left set 100C1 has a base 106 which is secured to the right side of left segment 86A and extends to the right to its tip 108. Each of the teeth in set 100C1 thus tapers to the right and inwardly to tip 108. More particularly, each tooth 102 in set 100C1 has an upper edge 202 which tapers or angles downwardly and to the right while facing upwardly and to the right. Each of said teeth 102 further includes a lower edge 204 which angles upwardly and to the right while facing downwardly and to the right. Each tooth in set 100C1 is bent to curve rearwardly and to the right so that each tip 108 projects into space 36 in a manner similar to tips 108 of set 100A. Thus, each tooth 102 in 100C1 has a convexly curved front surface 122 which curves from base 106 to the right and rearwardly to tip 108. Each tooth 102 in set 100C1 also includes a concavely curved rear surface 124 which curves from base 106 rearwardly and to the right to tip 108. The top and bottom edges 202 and 204 of each tooth 102 in set 100C1 curve rearwardly and to the right. Because the teeth 102 in rear left set 100C2 are mirror images of those in front left set 100C1, only the specific orientation distinguishes them from teeth in set 100C1. Thus, each tooth 102 in rear left set 100C2 curves from its base 106 to the right and forward to its tip 108 whereby the front and rear surfaces and top and bottom edges thereof also curve in an analogous fashion. Thus, the front of each tooth 102 in set 100C2 is concavely curved while the back surface is convexly curved.

The teeth 102 in front and back right sets 100D1 and 100D2 are respectively mirror images of teeth 102 in sets 100C1 and 100C2 and thus share corresponding characteristics. Thus, each tooth 102 in front right set 100D1 narrows from its base 106 to its point 108. More particularly, its upper edge 202 tapers or angles downwardly and to the left from base 106 to tip 108 while its lower edge 204 tapers upwardly and to the left from its base 106 to its tip 108. Since each tooth 102 in front right set 100D1 is bent rearwardly so that its tip 108 projects into lower space 36, each of said teeth 102 has a convexly curved triangular front surface 122 which curves rearwardly and to the left from base 106 to tip 108. Similarly, each of said teeth 102 has a triangular concavely curved back surface 124 which curves rearwardly and to the left from its base 106 to its tip 108. Each of its upper and lower edges 202 and 204 likewise curve rearwardly and to the left from base 106 to tip 108. The teeth 102 in back right set 100D2 are mirror images of the teeth 102 and front right set 100D1 and thus generally curve to the left and forward so that the tips 108 thereof project into lower space 36. Thus, each tooth 102 in set 100D2 has a triangular concavely curved front surface 126 which curves to the left and forward from its base 106 to its tip 108 and a triangular convexly curved back surface 128 which curves to the left and forward from its base 106 to its tip 108. The top and bottom edges 202 and 204 of each tooth 102 in set 100D2 also curves forward and to the left from its base 106 to its tip 108.

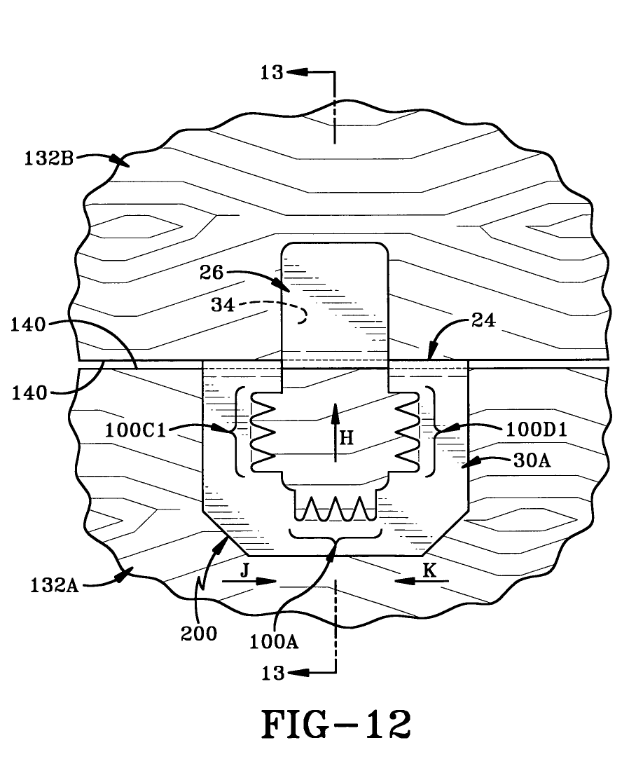

Clips 200 are used in the same fashion as described with clips 10 above. FIGS. 12 and 13 show one of clips 200 joining panels 132A and 132B in substantially the same manner as clip 10. However, the teeth in sets in 100C and 100D also dig into panel 132A and provide additional stability to clip 200. Like clip 10, the teeth in sets 100A and 100B dig into panel 132A and especially resist movement of clip 200 upwardly in the direction indicated at arrow H in FIG. 12. The teeth in sets 100C1 and 100C2 dig into panel 132A and particularly resist movement of clip 200 to the right (arrow J) while the teeth in sets 100D1 and 1 00D2 particularly resist movement of clip 200 to the left (arrow K). All of the teeth 102 tend to resist the movement of clip 200 relative to panel 132A in a direction which is parallel to its flat surfaces 142, but most particularly as just noted above.

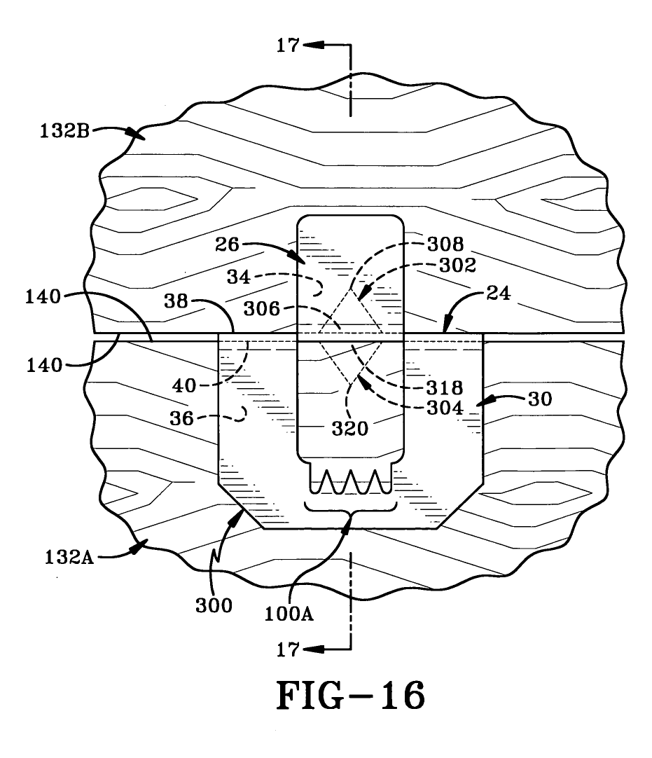

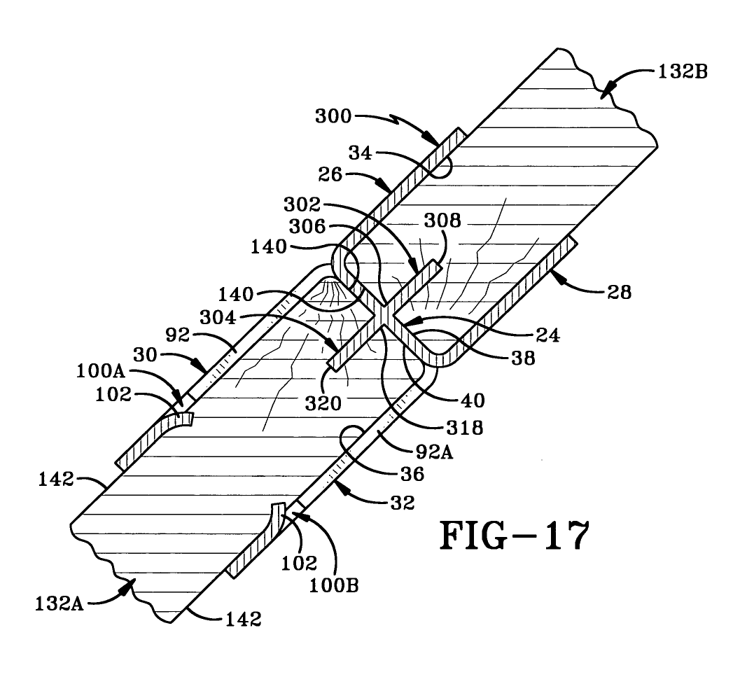

Clip 300 is now described with reference to FIGS. 14 and 15. Clip 300 is similar to clip 10 except for the inclusion of upper and lower base wall teeth 302 and 304 which are substantially identical to one another except for their relative inverted orientation. Each tooth 302 and 304 is generally triangular and flat and parallel to walls 26, 28, 30 and 32. Upper tooth 302 has a base 306 which is rigidly secured to top surface 38 of base wall 24 and extends upwardly therefrom to a pointed tip 308. Upper tooth 302 includes left and right sides or edges 310 and 312 which taper upwardly and toward one another from base 306 to tip 308. More particularly, left edge 310 tapers upwardly and to the right and faces upwardly and to the left. Right edge 312 tapers upwardly and to the left while facing upwardly and to the right. Tooth 302 further includes a vertical front flat triangular surface 314 and an opposed vertical back flat triangular surface 316. Each of surfaces 314 and 316 is parallel to one another and to the rear and front surfaces of walls 26 and 28.

Lower tooth 204 also includes a base 318 which is rigidly secured to bottom surface 40 of base wall 24 and extends downwardly therefrom to a pointed tip 320. Lower tooth 304 also includes left and right tapering sides or edges 322 and 324 which taper downwardly and toward one another to tip 320. More particularly, left edge 322 tapers downwardly and to the right while facing downwardly and to the left, and right edge 324 tapers downwardly and to the left while facing downwardly and to the right. Lower tooth 304 further includes vertical front and back flat triangular surfaces 326 and 328 which are parallel to the front and back surfaces of walls 30 and 32. As illustrated in FIG. 14 and 15, teeth 302 and 304 are positioned midway between the left and right sides of clip 300 and also midway between the front and rear of clip 300 with tooth 302 disposed directly between upper walls 26 and 28 and lower tooth 304 positioned directly between openings 92. However, teeth 302 and 304 may be positioned closer to one of the left and right sides of clip 300 or off center relative to its front and back as well.

During installation of clip 300, lower tooth 304 is forcibly inserted into panel 132A along its top edge 140 so that tip 320 of tooth 304 is positioned inwardly of and lower than edge 140 and base 318 is closely adjacent edge 140. Once clip 300 is secured on panel 132A, panel 132B is inserted between the front and rear upper walls 26 and 28 so that upper tooth 302 is forcibly inserted into panel 132B along its lower edge 140 whereby tip 308 is disposed inwardly of and higher than said edge 140, and base 306 is closely adjacent edge 140. Teeth 302 and 304 further assist in preventing deflection of panels 132A and 132B relative to one another. Unlike clips 10 and 200, the use of upper tooth 302 does inhibit the lateral sliding movement of panel 132B relative to 132A, as previously illustrated at arrow G, with reference to clip 10. However, upper tooth 302 only minimally inhibits upward movement of panel 132B relative to clip 300 and panel 132A because tooth 302 does not have overhanging portions which create the barb-like nature of teeth 102. While clip 10 is formed without either of teeth 302 and 304 while clip 300 includes both of said teeth, the invention contemplates using either one of teeth 302 and 304 without the other if desired.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A panel clip for use with a first panel having a first edge and a second panel having a second edge, the clip comprising:
a base wall having a front, a back, a left side and a right side;
front and back lower walls which are secured to and extend downwardly from the base wall in a cantilever fashion to define therebetween a lower panel-edge receiving space configured to receive the first edge of the first panel;
front and back upper walls which are secured to and extend upwardly from the base wall in a cantilever fashion to define therebetween an upper panel-edge receiving space configured to receive the second edge of the second panel so that the first and second panels are substantially coplanar when the first and second edges are received respectively in the upper and lower spaces; wherein the upper and lower walls are substantially parallel; and
a first front tooth having a base secured to the front lower wall and extending upwardly therefrom in cantilever fashion to a tip which extends into the lower space whereby the first front tooth is configured to engage the first panel to inhibit removal of the first panel from the lower space.

2. The panel clip of claim 1 wherein the lower front wall and the first front tooth share a common front surface.

3. The panel clip of claim 1 wherein the first front tooth has a convexly curved front surface and a concavely curved back surface.

4. The panel clip of claim 1 wherein the first front tooth has triangular front and back surfaces each of which extends upwardly and rearwardly.

5. The panel clip of claim 4 wherein the first front tooth has one of a left edge which tapers upwardly to the right and a right edge which tapers upwardly to the left.

6. The panel clip of claim 5 wherein the left and right edges and the back surface intersect at a first common point.

7. The panel clip of claim 6 wherein the left and right edges and the front surface intersect at a second common point forward of the first common point.

8. The panel clip of claim 1 wherein the first front tooth is bent to extend upwardly and rearwardly.

9. The panel clip of claim 1 wherein the tip is a sharp pointed tip which points upwardly and rearwardly.

10. The panel clip of claim 1 wherein the clip in its entirety is formed of a single piece of stamped sheet metal.

11. The panel clip of claim 1 further comprising a second front tooth spaced to the right of the first front tooth and having a base secured to the first lower wall and extending upwardly therefrom in cantilever fashion to a tip which extends into the lower space whereby the second front tooth is configured to engage the first panel to inhibit removal of the panel from the lower space.

12. The panel clip of claim 11 wherein the first and second teeth define therebetween a triangular space.

13. The panel clip of claim 1 wherein the front lower wall has a U-shaped configuration and comprises a bottom segment with left and right segments connected to and extending upwardly therefrom so that the left and right segments define therebetween an opening through the front lower wall in communication with the lower space; and the first front tooth extends upwardly from the bottom segment into the opening.

14. The panel clip of claim 13 further comprising one of (a) a left front tooth connected to and extending in a cantilever fashion from the left wall segment to the right into the opening and to a tip which extends into the lower space whereby the left front tooth is configured to engage the first panel to inhibit removal of the first panel from the lower space; and (b) a right front tooth connected to and extending in a cantilever fashion from the right wall segment to the left into the opening and to a tip which extends into the lower space whereby the right front tooth is configured to engage the first panel to inhibit removal of the first panel from the lower space.

15. The panel clip of claim 14 further comprising the other of the left and right front tooth.

16. The panel clip of claim 1 further comprising an opening formed through the front lower wall in communication with the lower space; and one of (a) a left front tooth connected to and extending in a cantilever fashion from the left wall segment to the right into the opening and to a tip which extends into the lower space whereby the left front tooth is configured to engage the first panel to inhibit removal of the first panel from the lower space; and (b) a right front tooth connected to and extending in a cantilever fashion from the right wall segment to the left into the opening and to a tip which extends into the lower space whereby the right front tooth is configured to engage the first panel to inhibit removal of the first panel from the lower space.

17. The panel clip of claim 1 wherein the front upper wall has a flat smooth back surface; and the back upper wall has a flat smooth front surface parallel to the back surface of the front upper wall whereby the flat smooth surfaces are configured to allow the second panel when received in the upper space to slide side to side, upwardly and downwardly therein.

18. The panel clip of claim 1 wherein the clip is free of an upper tooth or upper horizontally elongated ridge which is connected to one of the upper walls and extends into the upper space for engaging the second panel to inhibit removal of the second panel from the upper space.

19. A panel clip for use with a first panel having a first edge and a second panel having a second edge, the clip comprising:
a base wall having a front, a back, a left side and a right side;
front and back lower walls which are secured to and extend downwardly from the base wall in a cantilever fashion to define therebetween a lower panel-edge receiving space configured to receive the first edge of the first panel;
front and back upper walls which are secured to and extend upwardly from the base wall in a cantilever fashion to define therebetween an upper panel-edge receiving space configured to receive the second edge of the second panel so that the first and second panels are substantially coplanar when the first and second edges are received respectively in the upper and lower spaces; wherein the upper and lower walls are substantially parallel;
an opening formed through the front lower wall in communication with the lower space; and
one of (a) a left front tooth connected to and extending in a cantilever fashion from the left wall segment to the right into the opening and to a tip which extends into the lower space whereby the left front tooth is configured to engage the first panel to inhibit removal of the panel from the lower space; and (b) a right front tooth connected to and extending in a cantilever fashion from the right wall segment to the left into the opening and to a tip which extends into the lower space whereby the right front tooth is configured to engage the first panel to inhibit removal of the panel from the lower space.

20. A panel clip for use with a first panel having a first edge and a second panel having a second edge, the clip comprising:
a base wall having a front, a back, a left side and a right side;
front and back lower walls which are secured to and extend downwardly from the base wall in a cantilever fashion to define therebetween a lower panel-edge receiving space configured to receive the first edge of the first panel;
front and back upper walls which are secured to and extend upwardly from the base wall in a cantilever fashion to define therebetween an upper panel-edge receiving space configured to receive the second edge of the second panel so that the first and second panels are substantially coplanar when the first and second edges are received respectively in the upper and lower spaces; wherein the upper and lower walls are substantially parallel; and
one of (a) a lower base wall tooth connected to the base wall between the front and back lower walls and extending downwardly in a cantilever fashion from the base wall to a tip which is configured to be inserted into the first edge of the first panel when received in the lower space; and (b) an upper base wall tooth connected to and extending upwardly in a cantilever fashion from the base wall to a tip which is configured to be inserted into the second edge of the second panel when received in the upper space.
